(19) United States
(12) Patent Application Publication
(10) Pub. No.: US 2009/0015080 A1
(43) Pub. Date: Jan. 15, 2009

(54) Synchronous Machine Using the Fourth Harmonic

(75) Inventors: Rolf Vollmer, Gersfeld (DE); Markus Platen, Bad Neustadt (DE); Holger Schunk, Lendershausen (DE)

Correspondence Address: HENRY M FEIEREISEN, LLC;HENRY M FEIEREISEN, 708 THIRD AVENUE, SUITE 1501, NEW YORK, NY, 10017, US

(73) Assignee: Siemens Aktiengesellschaft, Munchen (DE)

(21) Appl. No.: 11/575,199

(22) PCT Filed: Sep. 9, 2005
(86) PCT No.: PCT/EP2005/054473

§ 371 Date: Mar. 13, 2007

(30) Foreign Application Priority Data
Sep. 15, 2004 (DE) 10 2004 044 701.2

(51) Int. Cl. H02K 5/24

(52) U.S. Cl. 310/51

(57) ABSTRACT

The invention relates to a permanently excited synchronous machine and a method for the suppression of harmonics. The permanently excited synchronous machine (51) comprises a stator (53) and a rotor (55). Preferably, the stator (53) comprises a three-phase winding and the rotor (55) comprises permanent magnets (57). The stator (53) has thirty-nine slots (1-39) and the rotor (55) has eight magnetic poles (79). The slots of the stator (53) are wound in such a way that a first harmonic can be suppressed by means of a winding scheme and a second harmonic can be suppressed by means of magnet geometry.

The invention relates to a permanent-magnet synchronous machine and a method for suppressing harmonics

Permanent-magnet synchronous machines, which excite a rotor by means of permanent magnets, have various advantages over electrically excited synchronous machines. By way of example, the rotor in a permanent-magnet synchronous machine does not require an electrical connection. Permanent magnets with high energy density, that is to say a high product of flux density and field strength, are found to be superior to lower-energy permanent magnets in this context. It is also known that permanent magnets may not only have a flat arrangement in relation to the air gap but may also be positioned in a type of collective configuration (flux concentration).

Permanent-magnet synchronous machines may encounter disadvantageous oscillating torques. Skewing of a rotor or stator in the permanent-magnet synchronous machine by one slot pitch, for example, as described for conventional motors in EP 0 545 060 B1, can result in a reduction in torque. In permanent-magnet synchronous machines with conventional winding, that is to say windings which are produced using a pull-in technique, skewing by one slot pitch is usually effected in order to reduce latching torques, which also result in oscillating torques.

In permanent-magnet synchronous machines, which have tooth-wound coils, it is possible to reduce the oscillating torques through particular shaping of the magnets, for example. A drawback of this is that particular shaping of the magnets results in increased production costs.

Depending on a winding for the stator in a 3-phase permanent-magnet synchronous machine and the design of the rotor in this synchronous machine, this synchronous machine also has e.m.f. harmonics. These e.m.f. harmonics concern the magnetic field-strength distribution in an air gap between the stator and the rotor. The e.m.f. harmonics cause oscillating torques.

Accordingly, the invention is based on the object of specifying a permanent-magnet synchronous machine in which oscillating torques, or latching torques, are reduced in simple fashion. This reduction is advantageously made without the use of skewing, for example of the permanent magnets.

The object in question is achieved by a method having the features of claim 1. It is also achieved by a permanent-magnet synchronous machine having the features of claim 3. Subclaims 2 and 4 to 6 disclose further advantageous developments of the invention.

A method for harmonics suppression in a permanent-magnet synchronous machine involves harmonics being reduced using a winding diagram and using a magnet geometry for permanent magnets in a rotor in the permanent-magnet synchronous machine. In this case, the permanent-magnet synchronous machine has a stator and a rotor, the stator preferably having a three-phase primary winding, and the rotor having permanent magnets. The winding diagram is used to reduce a first harmonic, and the magnet geometry is used to reduce a second harmonic. By way of example, the magnet geometry concerns the shape of the permanent magnets and/or the positioning of the permanent magnets (e.g. skewing of the permanent magnets) and/or the degree to which the rotor is covered with magnetic material, that is to say with permanent magnets.

For such a method, it is possible to design a corresponding permanent-magnet synchronous machine.

A permanent-magnet synchronous machine which also achieves the inventive object has a stator and a rotor. The stator has a three-phase primary winding, and the rotor has permanent magnets. In addition, the stator has 39 teeth and the rotor has 8 magnet poles.

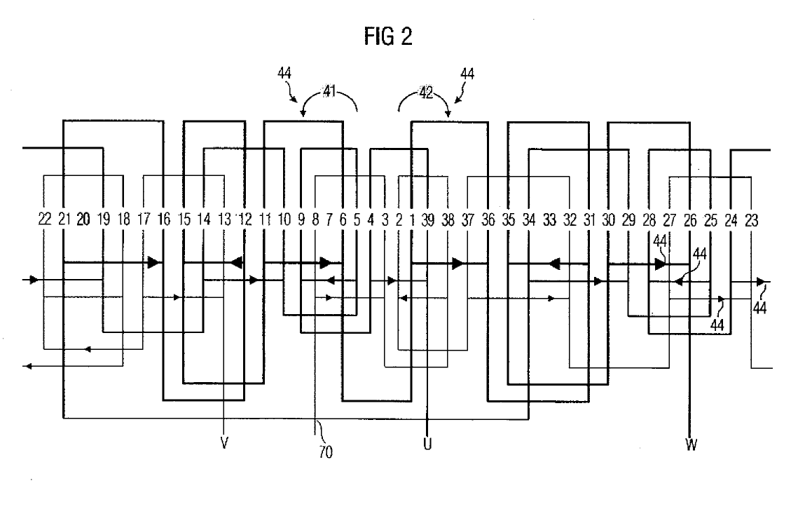

Using the embodiments described, it is possible for the permanent-magnet synchronous machine advantageously to have a high level of utilization and a high power factor. This is also the case particularly if the permanent-magnet synchronous machine has a winding diagram as shown in FIG. 2. The inventive permanent-magnet synchronous machine thus allows reduced latching torque formation with a particular combination comprising a number of slots in the stator and a particular number of poles on the rotor. The reduced latching torque formation results particularly from the winding design. The number of poles (=number of magnet poles) on the rotor indicates the number of useful poles. In line with the invention, the number of useful poles is 8.

In addition, it is possible to dispense with skewing and/or staggering (graded skewing) for the stator and/or for the rotor in order to reduce the latching torques in the inventive synchronous machine, since reduced torque ripple can be achieved merely by the design of said synchronous machine. The possible dispensing with skewing and/or staggering reduces the complexity for building the permanent-magnet synchronous machine.

A current-carrying winding on the stator can be used to produce a range of air-gap fields. In considering this range of air-gap fields, it is possible to distinguish between harmonic fields and a basic field over the 3600 periphery.

A number of basic pole pairs pg obtains as pg=1 in the case of the inventive permanent-magnet synchronous machine. The number of basic pole pairs pg is defined as follows: pg is the smallest number of pole pairs which is obtained from the Fourier analysis of the air-gap field. A number of useful pole pairs pn is obtained from the number of pole pairs on the rotor and is accordingly 4, since the rotor has 4 magnetic pole pairs.

For the permanent-magnet synchronous machine, this results in use of a fourth harmonic. The fundamental and the harmonics of a field-strength distribution in an air gap in an electrical machine can be ascertained by means of Fourier analysis, for example.

In one advantageous refinement, the winding on the stator is such that, in particular, disturbing harmonics such as the fifth (5pn) and seventh (7pn) harmonics have only a small amplitude. The fifth and seventh harmonics are disadvantageous particularly because they have opposite directions of rotation and, at the rotor speed, respectively result in torque fluctuations at the sixth harmonic.

The fifth and seventh harmonics of the rotor field rotate at the rotor frequency. The stator field 5·pn rotates at ⅕ of the rotor frequency counter to the rotor rotation, and the stator field 7·pn rotates at 1/7 of the rotor frequency in the direction of rotation of the rotor. The stator and rotor fields at 5·pn and 7·pn encounter one another 6·pn times per rotor revolution and produce torque ripple at 6·pn per rotor revolution.

To reduce a fifth and a seventh harmonic, the winding has to date also been short-pitched, particularly in the case of synchronous machines, with 36 slots. Short-pitching the winding is also complex and can be avoided in the case of the permanent-magnet synchronous machine based on the invention.

In another advantageous refinement of the permanent-magnet synchronous machine, its stator has 39 slots, with three slots being unwound. In one advantageous refinement of the permanent-magnet synchronous machine, the three unwound slots are used for cooling the permanent-magnet synchronous machine. By way of example, a coolant can be passed through the slots. For this purpose, the slots in one embodiment also have additional cooling channels in them. The coolant is either gaseous or liquid. By way of example, the unwound slots can also be provided for holding a heat pipe or a cool jet, or these slots have an appropriate cooling device. The three slots are advantageously in an approximately symmetrical distribution in the stator.

Another embodiment of the inventive permanent-magnet synchronous machine is in a form such that the rotor has a covering of magnetic material of between essentially 77% and 87%. The magnetic material is essentially the permanent magnets. The design of the rotor is therefore such that the covering of magnetic material is between 77% and 87% of the pole pitch. A value of approximately 80% is preferred.

In a further embodiment of the permanent-magnet synchronous machine, the stator's winding diagram is in a form such that the seventh harmonic is virtually zero, that is to say is greatly reduced. In such a winding diagram, the stator has 39 slots which are numbered from 1 to 39. The slots are wound with a phase U, a phase V and a phase W so that current can be carried in three phases. The coils for the winding have a first winding direction and a second winding direction, where:
a) phase U has slots 39, 4, 5, 9, 10, 14, 19, 24, 25, 28, 29 and 34 filled (that is to say wound), with a first coil for phase U being produced in slots 39 and 4 in the first winding direction, a second coil for phase U being produced in slots 5 and 9 in the second winding direction, a third coil for phase U being produced in slots 10 and 14 in the first winding direction 41, a fourth coil for phase U being produced in slots 19 and 24 in the first winding direction 41, a fifth coil for phase U being produced in slots 25 and 28 in the second winding direction 42 and a sixth coil for phase U being produced in slots 29 and 34 in the first winding direction 41, and
b) phase V has slots 13, 17, 18, 22, 23, 17, 32, 37, 38, 2, 3 and 8 filled, with a first coil for phase V being produced in slots 13 and 17 in the first winding direction 41, a second coil for phase V being produced in slots 18 and 22 in the second winding direction 42, a third coil for phase V being produced in slots 23 and 27 in the first winding direction 41, a fourth coil for phase V being produced in slots 32 and 37 in the first winding direction 41, a fifth coil for phase V being produced in slots 38 and 2 in the second winding direction 42, and a sixth coil for phase V being produced in slots 3 and 8 in the first winding direction 41, and
c) phase W has slots 26, 30, 31, 35, 36, 1, 6, 11, 12, 15, 16 and 21 filled, with a first coil for phase W being produced in slots 26 and 30 in the first winding direction 41, a second coil for phase W being produced in slots 31 and 35 in the second winding direction 42, a third coil for phase W being produced in slots 36 and 1 in the first winding direction 41, a fourth coil for phase W being produced in slots 6 and 11 in the first winding direction 41, a fifth coil for phase W being produced in slots 12 and 15 in the second winding direction 42 and a sixth coil for phase W being produced in slots 16 and 21 in the first winding direction 41, and
d) slots 7, 20 and 33 are free of a winding filling. Slots 7, 20, 33 are therefore unoccupied.

The fact that the permanent magnets on the rotor or else the slots in the stator no longer need to be skewed results in various advantages, such as:
there is no longer a loss of utilization as a result of the skew factor,
expensive skewed permanent magnets can be replaced by inexpensive straight permanent magnets,
if the slots in the stator needed to be skewed on the basis of the prior art, less expensive and/or faster production methods can now be used for forming the slots and for winding,
without skewing, production means for fitting the rotor with permanent magnets and/or magnetizing magnetic raw material can be simplified,
production is simpler to automate,
winding the slots in the stator is simpler because three slots are not wound,
the slots which are unwound can have sensors (e.g. temperature sensors) positioned in them which measure the temperature, for example.

To improve the harmonic response further and to improve the torque ripple additionally, the inventive permanent-magnet synchronous machine allows additional measures to be implemented such as skewing the permanent magnets on the rotor and/or skewing the windings in the stator and/or an appropriate staggering and/or short-pitching of the windings. The additional use of these means can also be used to improve the permanent-magnet synchronous machine to the extent that these measures allow further unwanted harmonics to be reduced. By way of example, it is thus possible for every single measure to be used to reduce another harmonic and to bring about an improvement in the harmonic response.

In addition, the permanent-magnet synchronous machine can be configured such that there is a number of holes q=13/8. The number of holes q indicates over how many slots per pole the winding for a phase is split, that is to say that q is the number of slots per pole and phase.

To keep down latching torques for permanent magnets on the rotor with stator teeth, the number of slots and the number of poles need to be chosen such that the lowest common multiple is as high as possible.

In a further refinement of the permanent-magnet synchronous machine, edge regions of the permanent magnets are lowered such that this results in a larger air gap over the edges of the permanent magnets.

The invention has the advantage of a plurality of measures being combined, such as the selection of a number of poles and the selection of a number of slots, which together produce little latching (latching torque), and the application of a particular winding diagram to suppress the seventh harmonic. Added to this is the fact that the fifth harmonic can be suppressed by selecting an advantageous magnet geometry and/or magnet width. The fifth harmonic can also be suppressed by means of an advantageous magnet contour in addition to 80% pole coverage, for example. In particular, the magnetic field geometry concerns the coverage of the poles on the rotor with magnetic material. The winding diagram and/or the magnet geometry can also be modified such that the modification allows suppression of other harmonics than those mentioned by way of example.

The invention and advantageous refinements of the invention are explained in more detail by way of example with reference to the drawing, in which:

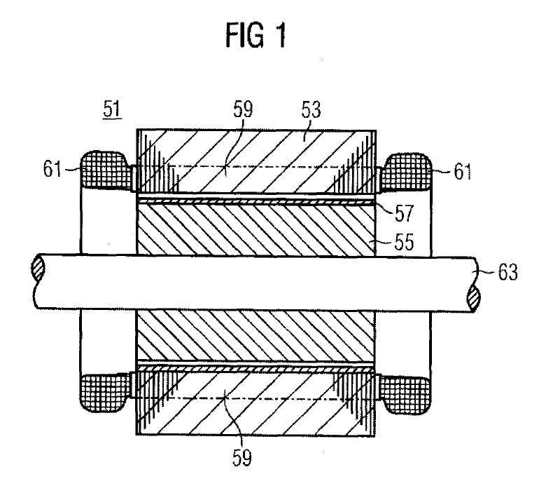

FIG. 1 schematically shows the design of a permanent-magnet synchronous machine,

FIG. 2 shows a winding diagram,

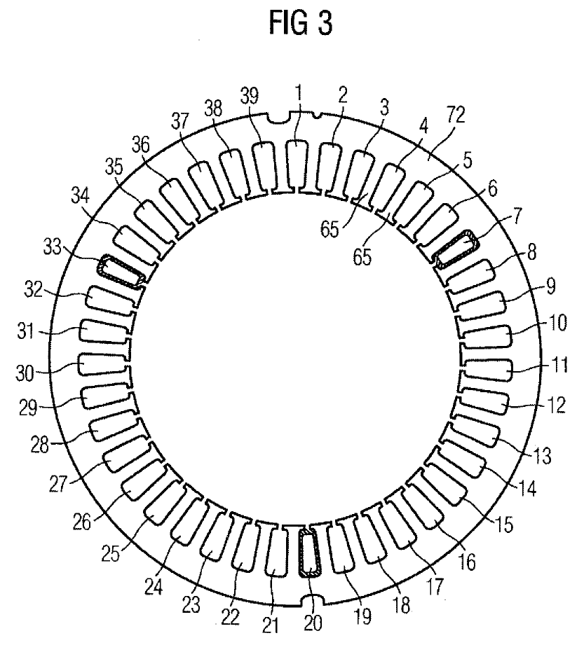

FIG. 3 shows a blanking tool for a stator which has 39 slots, with three slots not being wound,

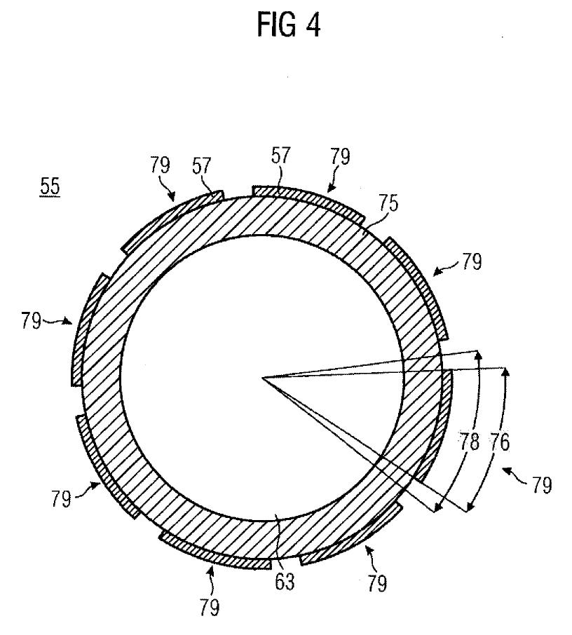

FIG. 4 shows a magnet coverage for the pole pitch and

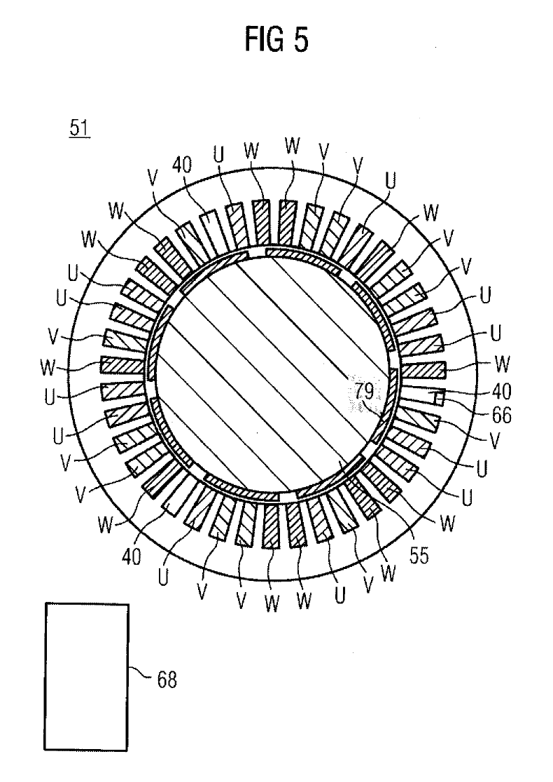

FIG. 5 shows a cross section through a schematically shown permanent-magnet synchronous machine.

The illustration shown in FIG. 1 shows a permanent-magnet synchronous machine 51 which has a stator 53 and a rotor 55. The rotor 55 has permanent magnets 57. The stator has coils 59, with the course of the coil 59 within the laminated stator 53 being shown in a dashed line. The coil 59 is used to form a winding. The coils 59 form winding heads 61. The permanent-magnet synchronous machine 1 is provided for the purpose of driving a shaft 63.

The illustration shown in FIG. 2 shows a winding diagram relating to a permanent-magnet synchronous machine which can carry three phases U, V, W of a three-phase current. The winding diagram for the stator in the permanent-magnet synchronous machine relates to a stator which has 39 slots. The 39 slots are labeled 1 to 39. The associated rotor, which is not shown in FIG. 2, has 8 poles (magnetic poles), that is to say 4 pole pairs. In line with the winding diagram in FIG. 2, the stator has 18 coils, FIG. 2 showing that one of the phases U, V and W has 6 respective coils. The winding shown in FIG. 2 has a star point 70. A star circuit is advantageous particularly when the third harmonic has not been eliminated. If the third harmonic is unimportant, the winding diagram can be modified such that a delta circuit is obtained, but this is not shown. The winding of the slots 1 to 39 is used to form coils. The coils have different winding directions 44, with the winding directions 44 being shown by means of arrows. FIG. 2 shows a first winding direction 41 and a second winding direction 42.

Phase U has slots 39, 4, 5, 9, 10, 14, 19, 24, 25, 28, 29 and 34 filled (wound), with a first coil for phase U being produced in slots 39 and 4 in the first winding direction 41, a second coil for phase U being produced in slots 5 and 9 in the second winding direction 42, a third coil for phase U being produced in slots 10 and 14 in the first winding direction 41, a fourth coil for phase U being produced in slots 19 and 24 in the first winding direction 41, a fifth coil for phase U being produced in slots 25 and 28 in the second winding direction 42, and a sixth coil for phase U being produced in slots 29 and 34 in the first winding direction 41.

Phase V has slots 13, 17, 18, 22, 23, 17, 32, 37, 38, 2, 3 and 8 filled (wound), with a first coil for phase V being produced in slots 13 and 17 in the first winding direction 41, a second coil for phase V being produced in slots 18 and 22 in the second winding direction 42, a third coil for phase V being produced in slots 23 and 27 in the first winding direction 41, a fourth coil for phase V being produced in slots 32 and 37 in the first winding direction 41, a fifth coil for phase V being produced in slots 38 and 2 in the second winding direction 42, and a sixth coil for phase V being produced in slots 3 and 8 in the first winding direction 41.

Phase W has slots 26, 30, 31, 35, 36, 1, 6, 11, 12, 15, 16 and 21 filled, with a first coil for phase W being produced in slots 26 and 30 in the first winding direction 41, a second coil for phase W being produced in slots 31 and 35 in the second winding direction 42, a third coil for phase W being produced in slots 36 and 1 in the first winding direction 41, a fourth coil for phase W being produced in slots 6 and 11 in the first winding direction 41, a fifth coil for phase W being produced in slots 12 and 15 in the second winding direction 42, and a sixth coil for phase W being produced in slots 16 and 21 in the first winding direction 41.

Slots 7, 20 and 33 are free of a winding filling, that is to say that they are unoccupied.

The illustration shown in FIG. 3 shows a blanking tool 72 for a stator which has 39 slots 1 to 39 and just as many teeth 65. Slots 7, 20 and 33 are provided for holding a cooling channel 34.

The illustration shown in FIG. 4 shows the rotor 55 in cross section. This illustration also shows a magnet coverage 76 for a pole pitch 78. The rotor 55 has 8 poles 79. The poles 79 are formed by means of permanent magnets 57. The permanent magnets 57 are fitted on a support 75. The support 75 is located on the shaft 63. In the illustration shown in FIG. 4, the magnet coverage 76 for each of the eight poles is approximately 80% of the pole pitch 78.

The illustration shown in FIG. 5 shows a cross section through a schematically illustrated permanent-magnet synchronous machine 51. FIG. 5 shows the occupation of slots by windings for the phases U, V and W. This is therefore a three-phase permanent-magnet synchronous machine. Three slots 40 are unoccupied here. The unoccupied slots 40 can have field sensors 66 inserted into them, for example, which are able to deliver signals for motor control 68. The rotor 55 has 8 poles 79 (magnetic poles). The winding diagram shown in FIG. 2 can be applied to a permanent-magnet synchronous machine as shown in FIG. 5. This has the advantage that in this way it is possible to obtain a high field amplitude for a useful shaft, and small field amplitudes in relation to the useful shaft can be achieved for the fifth and seventh harmonics.

A permanent-magnet synchronous machine designed on the basis of illustrations 2 and 5 has the following winding factors, in particular:

| | | 0 |
|---|---|---|
| ζs = | 1 | 0.03 |
| | 2 | 0.195 |
| | 3 | 1.329 · 10⁻³ |
| | 4 | 0.948 |
| | 5 | 0.031 |
| | 6 | 0.257 |
| | 7 | 0.159 |
| | 8 | 0.096 |
| | 9 | 0.231 |
| | 10 | 0.04 |
| | 11 | 0.018 |
| | 12 | 0.606 |
| | 13 | 0.144 |
| | 14 | 0.056 |
| | 15 | 0.135 |
| | 16 | 0.026 |
| | 17 | 0.196 |
| | 18 | 0.191 |
| | 19 | 0.211 |
| | 20 | 0.211 |
| | 21 | 0.191 |
| | 22 | 0.196 |
| | 23 | 0.026 |
| | 24 | 0.134 |
| | 25 | 0.057 |
| | 26 | 0.144 |
| | 27 | 0.607 |
| | 28 | 0.017 |

Here, the first column shows the number of pole pairs p and the second column shows the winding factor. The winding factor is calculated as follows:

$$ξ {s}_{p} := \vert \frac{{\sum }_{i = 0}^{k} ( {a}_{i} \cdot {e}^{j \cdot {φ}_{i , p}} )}{{\sum }_{i = 0}^{k} {a}_{i}} \vert$$

k+1 indicates the number of occupied slots for a phase. The winding factor is the quotient of the sum of the vector-added conductor voltages and the sum of the absolute values of the conductor voltages.

The vector aᵢ indicates amplitudes for the voltage vector of the conductor voltages.

The vector Φᵢ indicates the angles of the voltage vectors, with the vector wᵢ indicating whether a forward or return conductor is involved.

$$Amplitude a := ( \begin{matrix}1 \\ 1 \\ 1 \\ 1 \\ 1 \\ 1 \\ 1 \\ 1 \\ 1 \\ 1 \\ 1 \\ 1\end{matrix} )$$

$$Slot angle , mechanical α := ( \begin{matrix}0 \\ 46.15 \\ 83.07 \\ 92.307 \\ 129.23 \\ 138.46 \\ 175.38 \\ 221.53 \\ 267.69 \\ 276.92 \\ 304.61 \\ 313.84\end{matrix} )$$

$${φ}_{l , p} := ( {α}_{l , p} \cdot \frac{π}{180} ) + {w}_{l}$$

$$w := ( \begin{matrix}0 \\ π \\ 0 \\ 0 \\ π \\ π \\ 0 \\ π \\ 0 \\ 0 \\ π \\ π\end{matrix} )$$

$$where \text{:}$$

$$forward conductor = 0 and$$

$$return conductor = π$$

Where it holds that:

K:=11

j:=\sqrt{−1}

p:=1 . . . 100

l:=0 . . . k

1.-6. (canceled)

7. A method for harmonics suppression in a permanent-magnet synchronous machine that includes a stator and a rotor having permanent magnets, said method comprising the steps of:
suppressing a first given harmonic using a winding configuration; and
suppressing a second given harmonic using a magnet geometry, with the magnet geometry relating to a magnet width, a pole coverage, or both.

8. The method of claim 7, wherein the stator has a three-phase primary winding.

9. The method of claim 7 for use in a permanent-magnet synchronous machine including a stator having 39 slots, and a rotor including permanent magnets and interacting with the stator, said rotor having eight magnet poles.

10. A permanent-magnet synchronous machine, comprising:
a stator having 39 slots and a winding; and
a rotor including permanent magnets and interacting with the stator, said rotor having eight magnet poles.

11. The permanent-magnet synchronous machine of claim 10, wherein the stator has a three-phase primary winding.

12. The permanent-magnet synchronous machine of claim 11, wherein the stator has three slots in which the primary winding is not wound.

13. The permanent-magnet synchronous machine of claim 11, wherein each phase has twelve slots.

14. The permanent-magnet synchronous machine of claim 10, wherein between essentially 77% and 87% of the rotor has a covering of magnetic material.

15. The permanently excited synchronous machine of claim 10, wherein the hole number q=13/8.

16. The permanently excited synchronous machine of claim 10, wherein coils are wound in said slots, respective coils having either a first winding direction or a second winding direction, said winding having three phases, said slots being sequentially numbered 1-39, and
a) for the first phase a first coil is wound in slots 39 and 4 in the first winding direction, a second coil is wound in slots 5 and 9 in the second winding direction, a third coil for phase is wound in slots 10 and 14 in the first winding direction, a fourth coil is wound in slots 19 and 24 in the first winding direction, a fifth coil is wound in slots 25 and 28 in the second winding direction, and a sixth coil is wound in slots 29 and 34 in the first winding direction;
b) for the second phase a first coil is wound in slots 13 and 17 in the first winding direction, a second coil is wound in slots 18 and 22 in the second winding direction, a third coil is wound in slots 23 and 27 in the first winding direction, a fourth coil is wound in slots 32 and 37 in the first winding direction, a fifth coil is wound in slots 38 and 2 in the second winding direction, and a sixth coil is wound in slots 3 and 8 in the first winding direction, and
c) for the third phase a first coil is wound in slots 26 and 30 in the first winding direction, a second coil is wound in slots 31 and 35 in the second winding direction 42, a third coil is wound in slots 36 and 1 in the first winding direction 41, a fourth coil is wound in slots 6 and 11 in the first winding direction 41, a fifth coil is wound in slots 12 and 15 in the second winding direction 42, and a sixth coil is wound in slots 16 and 21 in the first winding direction 41, and
d) coils are not wound in slots 7, 20 and 33.
